(19) United States
(12) Patent Application Publication
(10) Pub. No.: US 2012/0282513 A1
(43) Pub. Date: Nov. 8, 2012

(54) CATHODIC ELECTRODE AND ELECTROCHEMICAL CELL

(75) Inventors: Tim Schaefer, Harztor (DE); Andreas Gutsch, Luedinghausen (DE)

(73) Assignee: LI-TEC BATTERY GMBH, Kamenz (DE)

(21) Appl. No.: 13/502,119

(22) PCT Filed: Oct. 12, 2010
(86) PCT No.: PCT/EP2010/006220

§ 371 Date: Jul. 25, 2012

(30) Foreign Application Priority Data
Oct. 14, 2009 (DE) 10 2009 049 326.3

(51) Int. Cl. H01M 4/525; H01R 43/16; H01M 2/16

(52) U.S. Cl. 429/144; 429/223; 29/874

(57) ABSTRACT

A cathodic electrode includes at least one carrier having at least one active material applied or deposited thereon, wherein the active material includes a mixture made of a lithium/nickel/manganese/cobalt mixed oxide (NMC), which is not present in a spinel structure, and a lithium manganese oxide (LMO) in a spinel structure. An electrochemical cell includes said cathodic electrode and a separator includes at least one porous ceramic material.

### CROSS-REFERENCE TO RELATED APPLICATIONS

This application is a National Phase application under 35 U.S.C. §371 of International Application No. PCT/EP2010/006220, filed Oct. 12, 2010 and published as WO 2011/045028 on Apr. 21, 2011, which claims priority to German patent application serial number DE 10 2009 049 326.3, filed Oct. 14, 2009, the entirety of each of which is hereby incorporated herein by reference.

### FIELD OF THE INVENTION

The present invention relates to a cathodic electrode and electrochemical cell.

### BACKGROUND AND SUMMARY

The present invention relates to a cathodic electrode for an electrochemical cell comprising at least one substrate, onto which at least one active material is coated or deposited, wherein the active material is a mixture of a lithium-nickel-manganese-cobalt composite oxide (NMC), which is not present in a spinell structure, and a lithium-manganese oxide (LMO) in a spinell structure.

The present invention furthermore relates to an electrochemical cell comprising a cathodic electrode having this active material, as well as an anodic electrode and a separator, which is at least partly arranged between these electrodes.

Said cathodic electrode, respectively, said electrochemical cell are preferably used in batteries, in particular in batteries having high energy density and/or high power density (so called “high power batteries” respectively “high energy batteries”). These batteries, having high energy and/or power density, are preferably used in power tools and electrically operated vehicles, for example in vehicles having a hybrid drive. Lithium-ion batteries are examples for those batteries.

According to the present invention, the cathodic electrode, respectively the electrochemical cell, is preferably used in lithium-ion cells and in lithium-ion batteries. Further preferably, said lithium-ion-cells and lithium-ion-batteries are used in power tools and in the drive system of vehicles, in particular in completely, as well as in essentially, electrically operated vehicles or in vehicles operated as a so called “hybrid”, i.e. together with a combustion engine. The use of these batteries together with fuel cells as well as in stationary applications is also encompassed.

In the field of battery technology, in particular with respect to lithium-ion batteries, it is generally known and accepted that the choice of the cathodic electrode material for the respective planned application is of particular relevance. Thus, active materials for use in portable electronic devices (communication electronics) are known, in particular lithium-cobalt oxides (e.g. LiCoO₂), lithium-manganese oxides (e.g. LiMn₂O₄) or lithium (nickel) cobalt aluminum oxides (NCA). These commercially and broadly used active materials are, however, not necessarily as appropriate for applications in electric vehicles or vehicles having an hybrid engine.

An active material for cathodic electrodes, which, in principle, can be used for electrochemical cells and batteries used in electronic tools, electrically operated driven vehicles or vehicles having an hybrid engine, are composite oxides of lithium together with nickel, manganese and cobalt (lithium-nickel-manganese-cobalt composite oxides, “NMC”). Lithium-nickel-manganese-cobalt composite oxides are preferred vis-à-vis lithium-cobalt oxides for safety reasons. Furthermore, lithium-nickel-manganese-cobalt composite oxides are preferred vis-à-vis lithium-polyanion compounds used as active materials, for example LiFePO₄ due to the energy density considerations (“LiPF” has an energy density which is about 50% lower than lithium-nickel-manganese-cobalt composite oxides, which is of particular relevance for non-stationary applications).

The active material according to the invention preferably used for cathodic electrodes, namely the nickel-manganese-cobalt composite oxides of lithium (also called “NCM” in some references) are sometimes seen as having a possible disadvantage in that the cathodic electrodes based on this composite oxide possibly show degradation due to aging in long time applications.

The decreased stability of NMC as cathodic electrode material may result in the use of a separator having a higher layer thickness with respect to electrochemical cells having cathodic and anodic electrodes and a separator.

Thus, the object of the present invention is to provide an improved active material for a cathodic electrode. The improved active material for a cathodic electrode should have the advantage of being safer, having comparable high energy and/or power density and/or having improved stability with respect to aging (operating life time).

A further object of the present invention is to provide an improved electrochemical cell. The improved electrochemical cell should have the advantages of having smaller dimensions but improved operating life time and thus an improved energy density and/or power density.

### DETAILED DESCRIPTION

The above-mentioned and other objects are solved according to the invention in that a cathodic electrode for an electrochemical cell is provided comprising at least one substrate on which at least one active material is applied or deposited, wherein the active material is a mixture of a lithium-nickel-manganese-cobalt composite oxide (NMC) which is not present in a spinell structure and a lithium-manganese oxide (LMO) in a spinell structure.

These objects are also solved according to the invention by providing an electrochemical cell with a cathodic electrode comprising
at least one substrate on which at least one active material is applied or deposited, wherein the active material is a mixture of a lithium-nickel-manganese-cobalt composite oxide (NMC), which is not present in a spinell structure, and a lithium-manganese oxide (LMO) in a spinell structure;
an anodic electrode; and
a separator which is arranged at least partly between these electrodes.

Therein, it is preferred that said separator comprises at least one porous ceramic material, preferably applied as a layer on an organic substrate material.

Said cathodic electrode, respectively said electrochemical cell, are preferably used in batteries which are preferably used in electronic tools and electrically operated vehicles, including vehicles having a hybrid engine or having fuel cells. The batteries used should exhibit high energy and/or power density.

The term “cathodic electrode” refers to an electrode which absorbs electrodes, if connected to a consumer load, for example during the operation of an electric motor. Thus, the cathodic electrode is, in this case, the “positive electrode”.

An “active material” of a cathodic or anodic electrode according to the invention is a material which is able to incorporate lithium in ionic or metallic or any other intermediate form. In particular, the material is able to incorporate lithium in a lattice structure (“intercalation”). The active material thus “actively” participates in the electrochemical reactions occurring during charging and discharging (in contrast to other possible components of the electrode like, for example, binder, stabilizer or substrate).

The cathodic electrode according to the invention comprises at least one active material, wherein the active material is a mixture of a lithium-nickel-manganese-cobalt composite oxide (NMC) which is not present in a spinell structure, and a lithium-manganese oxide (LMO) in a spinell structure.

It is preferred that the active material comprises at least 30 mole-%, preferably at least 50 mole-% NMC and, at the same time, comprises at least 10 mole-%, preferably at least 30 mole-% LMO, with respect to the total amount of active material of the cathodic electrode (thus not with respect to the cathodic electrode in total, which may, in addition to the active material, comprise electrically conductive additives, binder, stabilizer etc.).

It is preferred, that NMC and LMO together provide at least 60 mole-% of the active material, further preferred at least 70 mole-%, further preferred at least 80 mole-%, further preferred at least 90 mole-%, each with respect to the total amount of the active material of the cathodic electrode (thus not with respect to the cathodic electrode in total, which may comprise, in addition to the active material, electrically conductive additives, binder, stabilizer etc.).

Furthermore, it is preferred according to the invention that the active material essentially consists of NMC and LMO, thus not containing further active material in an amount of more than 2 mole-%.

Furthermore, it is preferred that the material deposited on the substrate is essentially active material which means 80 to 95 wt.-% of the material deposited on the substrate of the cathodic electrode is said active material, further preferred 86 to 93 wt.-%, each with respect to the total weight of the material (thus, with respect to a cathodic electrode without substrate in total, which may comprise, in addition to the active material, electrically conductive additives, binders, stabilizers, etc.).

With respect to the ratio of the weight parts of NMC as active material to LMO as active material it is preferred that this ratio is 9 (NMC):1 (LMO) up to 3 (NMC):7 (LMO), wherein 7 (NMC):3 (LMO) up to 3 (NMC):7 (LMO) is preferred, and wherein 6 (NMC):4 (LMO) up to 4 (NMC):6 (LMO) is further preferred.

According to the invention, the mixture of the preferred active material lithium-nickel-manganese-cobalt composite oxide (NMC) with at least one lithium-manganese oxide (LMO) results in a higher stability, in particular in an improved life time (cycle life) of the cathodic electrode. Without being bound by a theory in this respect, it is assumed that the improvements are due to the higher manganese portion compared to pure NMC. Therein, the high energy density and further advantages of the lithium-nickel-manganese-cobalt composite oxide (NMC) compared to lithium-manganese oxides (LMO) of the mixture are maintained to the greatest possible extent. Trials showed that the above-mentioned mixture of lithium-manganese-cobalt composite oxides almost shows no loss in capacity after 250 charging and discharging cycles or in a temperature aging test. The 80% capacity limit with respect to the original capacity was not reached prior to 25,000 complete cycles. The temperature aging test conducted in the fully charged state showed a superior stability compared to “pure” NMC which indicates a life time of more than twelve years. The temperature stability has also been improved.

The higher thermal stability of the cathodic electrode thus makes it possible to design a thinner separator layer in the electrochemical cell, wherein the reduced intrinsic resistance thus results in higher energy and power density of the cell (see the following embodiments related to the electrochemical cell of the cathodic electrode, separator and anodic electrode).

Composite oxides comprising cobalt, manganese and nickel, in particular single phase lithium-nickel-manganese-cobalt composite oxides, are known as possible active materials for electrochemical cells, as such, from the prior art (see, for example, the scientific article of Ohzuku of the year 2001 [T. Ohzuku et al., Chem. Letters 30 2001, pages 642 to 643] as well as WO 2005/056480 based thereon).

Generally, there are no restrictions with respect to the composition of the lithium-nickel-manganese-cobalt composite oxides other than these oxides have to contain, in addition to lithium, at least 5 mole-%, preferably at least 15 mole-%, further preferably at least 30 mole-% of nickel, manganese and cobalt, each with respect to the total amount of transition metals in the lithium-manganese-cobalt composite oxide. The lithium-nickel-manganese-cobalt composite oxide may be doped with any other metals, in particular transition metals, as long as it is assured that the above-mentioned molar minimum amounts of Ni, Mn and Co are present.

A lithium-nickel-manganese-cobalt composite oxide of the following stoichiometry is especially preferred: Li[Co_{1/3}Mn_{1/3}Ni_{1/3}]O₂, wherein the amount of Li, Co, Mn, Ni and O may vary of +/−5%.

These lithium-nickel-manganese-cobalt composite oxides according to the invention are not present in a spinell structure. Preferably, they are present in a layered structure, for example in a “O3-structure”. Further preferably, these lithium-nickel-manganese-cobalt composite oxides according to the invention are not subjected to a phase transition into a spinell structure (which means not by more than 5%) during charging and discharging.

Lithium-manganese oxides (LMO) are present in a spinell structure. Lithium-manganese oxides in a spinell structure and according to the invention comprise at least 50 mole-%, preferably at least 70 mole-%, further preferably at least 90 mole-% manganese as transition metal with respect to the total amount of transition metal present in the oxide. A particularly preferred stoichiometry of the lithium-manganese oxide is Li₁₊ₓMn_{2-y}M_{y}O₄ wherein M is at least a metal, in particular at least a transition metal, and −0.5 (preferably −0.1)≦x≦0.5 (preferably 0.2) and 0≦y≦0.5.

The “spinell structure” as required here the most common crystal structure for compounds of the type ABₓX₄ named according to its main representative, the mineral “spinell” (magnesium-aluminate, MgAl₂O₄) and well-known to the person skilled in the art. The structure consists of a cubic closest packing (ccp) of the chalcogenide (here: oxygen) ions wherein the tetrahedron or octahedron interstitial sites are (partly) occupied by the metal ions. Spinells are exemplarily described as cathode materials for lithium-ion cells in Chapter 12 of “Lithium Batteries” published by Nazri/Pistoia (ISBN: 978-1-4020-7628-2).

Pure lithium-manganese oxide may be present, exemplarily, in the stoichiometry of LiMn₂O₄. The lithium-manganese oxides used according to the invention are preferably modified and are stabilized, since pure LiMn₂O₄ has the disadvantage that Mn-ions are extracted from the spinell structure under certain conditions. In principle, there are no restrictions how the stabilization of the lithium-manganese oxides is achieved, as long as lithium-manganese oxides are maintained stable during the desired life time under the operation conditions of the lithium-ion cell. With respect to known stabilization methods, reference is made to, e.g., WO 2009/011157, U.S. Pat. No. 6,558,844, U.S. Pat. No. 6,183,718 or EP 0 816 292. These publications describe the use of stabilized lithium-manganese oxides in a spinell structure as the cell active material for cathodic electrodes in lithium-ion batteries. Particularly preferred stabilizing methods comprise doping and coating.

There are no restrictions with respect to the way of how the two active materials NMC and LMO are mixed. Physical mixtures (e.g. mixing of particles or powders, in particular by input of energy) or chemical mixtures (e.g. combined deposition from the gas phase or in aqueous phase, for example dispersion) are preferred, wherein it is preferred that the two active materials are present as a homogenous mixture as the result of a mixing process, which means that both components cannot be identified as separate phases without physical means.

Preferred mixtures are present as homogenous powders or pastes or dispersions. In a preferred embodiment, the mixture is produced continuously and applied as well as compacted to an electrode by means of paste extrusion, optional without prior mixing and drying.

With respect to the mixtures, it is preferred that the lithium-nickel-manganese-cobalt composite oxide and the lithium-manganese oxide are each present in particulate form, preferably as particles having an average diameter of 1 μm to 50 μm, preferably 2 μm to 40 μm, further preferably 4 μm to 20 μm. The particles can also be secondary particles which are constituted based on primary particles. The above-mentioned average diameters then relate to the secondary particles.

A homogenous and intense mixing of both phases, in particular of both phases in particulate form, contributes to the advantageous effect of the aging resistance of the lithium-nickel-manganese-cobalt composite oxide of this mixture.

Other types of “mixture”, for example the alternating deposition of layers on a substrate or the coating of NMC-particles using LMO, are also possible.

The active material according to the invention is “applied” onto a substrate. There are no restrictions with respect to this “applying” of the active material onto the substrate. The active material may be applied as a paste or as a powder or can be deposited from the gas phase or a liquid phase, for example as a dispersion.

An extrusion method is preferred. Preferably, the active material is directly applied as paste or dispersion to the cathodic electrode. A laminated composite is produced by coextrusion with other components of the electrochemical cell, in particular the anodic electrode and the separator (see discussion to extrudents and laminates below). Such methods are, for example, disclosed in EP 1 783 852. The terms “paste” and “dispersion” are used interchangeably.

It is preferred that the active material is not applied onto the substrate as such, but together with other, non-active (which means: not lithium incorporating) components.

Therein, it is preferred that, in addition to the at least one active material, at least one binder or one binder system is present, i.e. is a component of the cathodic electrode (without substrate). The binder may be, or may comprise SBR, PVDF, a PVDF-homo- or -copolymer (like, for example, Kynar 2801 or Kynar 761).

The cathodic electrode optionally comprises a stabilizer, for example Aerosil or Sipernat. It is preferred that these stabilizers are present in a weight ratio of up to 5 wt.-%, preferably up to 3 wt.-%, with respect to the total weight of the mass applied to the substrate of the cathodic electrode.

It is preferred, if this stabilizer contains a separator as described below, which is a separator comprising at least one porous ceramic material, in particular the “Separion” material described below as powdery additive, preferably in a weight ratio of 1 wt.-% to 5 wt.-%, further preferably 1 wt.-% to 2.5 wt.-%, with respect to the total weight of the mass applied to the substrate of the cathodic electrode. This results in particularly stable and secure cells, in particular with respect to an electrochemical cell having a separator layer comprising at least one porous ceramic material as described below.

Furthermore, it is preferred that at least one electrically conductive additive is present in addition to the at least one active material (as well as, if required, in addition to the at least one binder or binder system and/or the at least one stabilizer), i.e. as a component of the cathodic electrode (without substrate). Such electrically conductive additives comprise, for example, carbon black (Enasco) or graphite (GS 6), preferably in a weight ratio of 1 wt.-% to 6 wt.-%, further preferably 1 wt.-% to 3 wt.-%, each with respect to the total weight of the mass applied to the substrate of the cathodic electrode. All these structural materials, in particular structural materials in the nanometer range or conductive carbon-“nanotubes” like, for example, Bayer's “Baytubes®” may be introduced.

The previously defined active materials for the electrodes, in particular for the cathodic electrode, are present on a substrate. According to the invention there are no restrictions with respect to the substrate or the material of the substrate other than that it must be suitable to support the at least one active material, in particular the at least one active material of the cathodic electrode. Furthermore, said substrate should be essentially inert, respectively inert to the greatest possible extent, vis-à-vis the active material during the operation of the cell, respectively the battery, in particular during charging and discharging. The substrate may be homogeneous, or may be or comprise a layered structure, or may be or comprise a composite material.

Preferably, the substrate contributes to the charge or discharge of electrons. Thus, the material of the substrate is preferably at least partly electrically conductive, preferably electrically conductive. In this embodiment, the material of the substrate preferably comprises aluminum or copper or consists of aluminum or copper. The substrate is preferably connected to at least one electronic conductor.

The substrate may be coated or may not be coated and may be a composite material.

In a further embodiment according to the invention the above-described cathodic electrode is used in an electrochemical cell, wherein this electrochemical cell comprises:
a cathodic electrode comprising at least one substrate onto which at least one active material is applied or deposited, wherein the active material is a mixture of a lithium-nickel-manganese-cobalt composite oxide (NMC), which is not present in a spinell structure, together with a lithium-manganese oxide (LMO) in a spinell structure, as well as
at least one anodic electrode, and
at least one separator, which (each) is at least partly arranged between these electrodes.

All above-mentioned embodiments are preferred with respect to the cathodic electrode for said electrochemical cell.

The term “anodic electrode” relates to the electrode which releases electrons if connected to a consumer load, for example an electrical motor. Thus, the anodic electrode is, in this case, the “negative electrode”.

In general, there are no restrictions with respect to the anodic electrode besides that the electrode has to enable the incorporation and extraction of lithium ions. The anodic electrode preferably comprises carbon and/or lithium titanate, further preferably coated graphite.

In a very preferred embodiment of the electrochemical cell an anodic electrode is used comprising coated graphite. Thereby, it is especially preferred that the anodic electrode comprises conventional graphite or so called “soft” carbon, which is coated with harder carbon, in particular with “hard carbon”. Therein, this harder carbon has a hardness of ≧1,000 N/mm², preferably of ≧5,000 N/mm².

The “conventional” graphite can be natural graphite like UFG8 of Kropfmühl. Therein, a C-fiber amount of up to 38% is optional.

Preferably, the amount of “hard carbon” relative to “hard carbon+soft carbon” is at most 15%.

According to the invention, an anodic electrode comprising conventional graphite (“soft carbon”, natural graphite) which is coated with “hard carbon”, together with the cathodic electrode, notably increases the stability of the electrochemical cell.

Preferably, the electrodes, as well as the separator, are present as layers, as foils or as stacks. This means, that the electrodes as well as the separator are constituted as layers or as layers of the corresponding materials or substances. Within the electrochemical cell, these layers or stacking tiers can be arranged above each other, and laminated or wound.

It is preferred according to the invention, that the layers or stacks are arranged above each other without being laminated.

The separators used in the subject electrochemical cells, respectively batteries, separating the cathodic electrode from the anodic electrodes, should be designed such that they enable an easy passage of charge carriers.

The separator is ionically conductive and preferably comprises a porous structure. The separator enables lithium ions passing through the separator in case of electrochemical cells working with lithium ions.

It is preferred that the separator comprises at least one inorganic material, preferably a ceramic material. Therein, it is preferred that the separator comprises at least one porous ceramic material, preferably as a layer applied onto an organic substrate material.

In principle, such a separator is known from WO 99/62620, respectively can be produced according to the methods disclosed therein. Such a separator is also commercially available under the tradename Separion® from Evonik.

Preferably, the ceramic material is chosen from the group of oxides, phosphates, sulfates, titanates, silicates, aluminum-silicates, borates of at least one metal ion.

Furthermore, it is preferred that oxides of magnesium, calcium, aluminum, silicon, zirconium and titanium are used as well as silicates (in particular zeolithes), borates and phosphates. Substances for separators like these as well as methods for production of these separators are disclosed in EP 1 783 852.

Such a ceramic material comprises sufficient porosity for the function of an electrochemical cell that is considerably more temperature resistant and also shrinks less at higher temperatures compared to conventional separators which do not comprise a ceramic material. A ceramic separator furthermore comprises an advantageous high mechanical stability.

In particular in combination with an active material according to the invention for the cathodic electrode, which leads to a higher thermal stability and aging resistance, this layer thickness of the ceramic separator can be reduced such that the cell dimensions are reduced and thus the energy density can be increased, wherein the safety as well as the mechanical stability are superior.

Separator thicknesses of 2 to 50 μm, in particular 5 μm to 25 μm, and further 10 to 20 μm are preferred for electrochemical cells according to the invention. The increased thermal stability and aging resistance of the cathodic electrode—as shown above—allow for the separator layer thickness and its intrinsic resistance to be minimized compared to separators of the art, thus reaching smaller cell impedance.

Furthermore, it is preferred that the inorganic substance, respectively the ceramic material is present in the form of particles having a maximum diameter of below 100 nm. These are preferably present on an organic substrate material.

The separator preferably is coated with polyetherimide (PEI).

Preferably, an organic material is used as substrate material for the separator, which is preferably designed as a non-woven fabric, wherein the organic material preferably comprises a polyethylene-glycol-terephthalate (PET), a polyolefine (PO) or a polyether imide (PEI). The substrate material is advantageously designed as a foil or a thin layer.

In a particularly preferred embodiment, said organic material is a poly-ethylene-glycol-terephthalate (PET).

The organic material is preferably coated with an inorganic ion conducting material, which is preferably ion conducting in a temperature range of −40° C. to 200° C.

In a preferred embodiment of the separator, which is preferably present as a composite of at least one organic substrate material together with at least one inorganic (ceramic) substance, said separator is designed as a layered composite in form of a foil, which is preferably coated on one side, or both sides, with a polyether imide.

In a preferred embodiment of the separator, the separator consists of a layer of magnesium oxide which is coated, preferably on one side or both sides, with a polyether imide.

In a further embodiment, 50 to 80 wt.-% of the magnesium oxide can be substituted by calcium oxide, barium oxide, barium carbonate, lithium-, sodium-, potassium-, magnesium-, calcium-, barium-phosphate or by lithium-, sodium-, potassium-borate or mixtures of these compounds.

In a preferred embodiment, the polyether imide, as coated onto the layer of the inorganic substance on one or both sides, is preferably present as a non-woven fabric as described above in regard to the separator. The term “non-woven fabrics” means that the fibers are present in a non-woven manner. Such non-woven fabrics are known from the prior art and/or may be produced by methods known, for example using a spin bonding method or a melt blowing method as cited in DE 195 01 271 A1.

Polyether imides are polymers known and/or can be produced according to methods known. Such methods are, for example, disclosed in EP 0 926 201. Polyether imides are commercially available, for example, under the trade name Ultern®. Said polyether imide can be present in the separator according to the invention in one layer or in several layers, each coated on one side and/or on both sides of the layer of the inorganic material.

In a preferred embodiment, the polyether imide comprises a further polymer. This at least further polymer is preferably selected from the group consisting of polyester, polyolefin, polyacrylnitrile, polycarbonate, polysulfone, polyethersulfone, polyvinylidenfluoride, polystyrol.

Preferably, the further polymer is a polyolefin. Preferred polyolefins are polyethylene and polypropylene.

The polyether imide, preferably in form of the non-woven fabrics, is preferably coated by one or more layers of the further polymer, preferably the polyolefin, which is preferably also present as non-woven fabrics.

The coating of the polyether imide with the further polymers, preferably the polyolefins may be achieved by adhesion, lamination, chemical reaction, welding or by mechanical conjunction. Such polymer composites as well as methods for their production are known from EP 1 852 926.

Preferably, the non-woven fabrics are produced from nanofibers or technical glasses of the polymers used. Thus, non-woven fabrics are produced having a high porosity wherein small pore diameters are formed.

The fiber diameter of the polyether imide non-woven fabrics is preferably larger than the fiber diameter of the further polymer non-woven fabrics, preferably the polyolefin non-woven fabrics.

Preferably, the non-woven fabrics of polyether imide have a higher pore diameter than the non-woven fabrics produced from the further polymer.

The use of a polyolefin in addition to polyether imide ensures higher safety of the electrochemical cell since the pores of the olefin shrink if the cell warms up too strongly or undesirably and thus the charge transport through the separator is reduced, respectively terminated. If the temperature of the electrochemical cell is increased to such an extent that the polyolefin starts melting, the polyether imide, stable against temperature influence, works against the melt-down of the separator and thus against an uncontrolled destruction of the electrochemical cell.

Advantageously, the ceramic separator is made of a flexible ceramic composite material. The composite material is produced of different, tightly bonded materials. In particular, it is envisioned that this composite material is made of ceramic materials and polymeric materials. It is known to add a ceramic treatment, respectively coating, to a non-woven fabric of PET. Such composite materials can resist temperatures of above 200° C. (partly up to 700° C.).

Advantageously, a separator layer, respectively a separator, at least partly extends over a boundary edge of at least one electrode, in particular a neighboring electrode. It is particularly preferred that a separator layer, respectively a separator, extends over all boundary edges of, in particular neighboring electrodes. Thus, electrical currents between the edges of electrodes of an electrode pack are reduced.

To produce an electrochemical cell according to the invention, methods can be used which are generally known, and, for example, are described in “Handbook of Batteries”, Third Edition, McGraw-Hill, Editors: D. Linden, T. B. Reddy, 35.7.1.

In one embodiment, the separator layer is formed directly on the negative or the positive electrode or on the negative and the positive electrode.

Preferably, the inorganic substance of the separator is applied as a paste or a dispersion directly onto the negative electrode and/or the positive electrode. The laminate composite is produced by coextrusion. A paste extrusion is particularly preferred for the present invention.

In this case, the laminate composite comprises an electrode and a separator, respectively, both electrodes and the separator arranged there between.

After extrusion, the composite produced can be dried, respectively filtered, by using common methods, if necessary.

It is also possible to produce the anodic electrode and the cathodic electrode as well as the layer of the inorganic substance, which is the separator, separately from each other. The inorganic substance, respectively, the ceramic material is/are then preferably designed as a foil. The electrodes and the separator, as produced separately from each other, are continuously delivered to a processing unit where the combined negative electrode, separator and the positive electrode are laminated as a cell composite. The processing unit comprises or consists preferably of laminating rolls. Such a method is known from WO 01/82403.

### EXAMPLES

In the following, the production of an electrochemical cell according to the invention is described having two electrodes, in particular a cathodic electrode, and a separator in an electrolyte and housing.

A considerably smaller separator thickness can be chosen due to the increased thermal stability and aging resistance of the cathodic electrode (i.e. according with the invention and, compared to the use of lithium-nickel-manganese-cobalt composite oxide only as the cathodic electrode). Thus, in total, a higher energy and power density is achieved.

a) Fibers having an average fiber diameter of about 2 μm are spun electrostatically starting from dimethyl formamide polyether imide and further processed to a non-woven fabric, which comprises a thickness of about 15 μm.

b) 25 weight parts LiPF₆ and 20 weight parts ethylene carbonate, 10 weight parts propylene carbonate or EMC, 25 weight parts magnesium oxide and 5 g Kynar 2801®, a binder are mixed together and dispersed in a dispenser until a homogenous dispersion is produced.

c) A dispersion produced according to b) is applied to the non-woven fabrics produced according to a) such that the applied layer comprises a thickness of about 20 μm (separator).

d) A mixture of 75 weight parts MCMB 25/28® (mesocarbon microbeads; Osaka Gas Chemicals), 10 weight parts lithiumoxalatoborate, 8 weight parts Kynar 2801® and 7 weight parts propylene carbonates are applied on an aluminum foil having a thickness of 18 μm by means of an extruder. The thickness of the layer applied is about 20 to 40 μm (anodic electrode).

e) A paste mixture of 50 weight parts lithium-nickel-manganese-cobalt composite oxide (NMC) in layered structure, 30 weight parts lithium-manganese oxide (LMO) in a spinell structure, 10 weight parts Kynar 2801® and 10 weight parts propylene carbonate is coated on an aluminum foil having a thickness of 18 μm (cathodic electrode).

f) The layers produced according to c), d), and e) are wound on a winding machine such that the product according to c) is arranged between the coatings of the products according to d) and e), wherein the polyether imide non-woven fabric contacts the coating of the product according to Example e). The metal foils are provided with conductors and the whole system is housed in a shrinking foil.

The subsequent section applies for the production of cathodic electrodes in general:

The total content NMC/LMO is LMO 86 to 93%, the latter in reduction of the and in relation to the remaining components is preferred in high dynamic cells.

A component of the electrolyte, but also a mixture, for example EC/EMC 3:1 can be used as flow aid during extrusion.

Manufacture in kneaders, which can be operated in an inert manner and essentially water free, TP-65 grd TP and lower, is preferred.

Advantageously and according to the invention is the production of electrodes or of the cell laminate by paste extrusion. The active materials are dosed into a paste extruder (for example Common Tec), which works according to the principle of a piston rod press, and then pressed through a nozzle. The lubricant contained in the extrudate is removed in a drying zone and the extrudate is then sintered and/or calandered subsequently. Thus, abrasion is minimized which contributes to an increased life time of the aggregates and the cells. Energy is saved, since extrusion can be conducted at room temperature and complex, controlled homogenous heating is not necessary. Also, the odor nuisance due to fumes of the softener is minimized at the extruder.

Preferably, during paste extrusion, compounds like scavengers or ionic liquids are also extruded by means of microinjections. The compounds result in an elongated life time of the cells. Extrusion of these compounds may occur, for example, by injection over an area/mass of extruded compounds or stabilizers, respectively, additives like vinylene carbonate or fire retardants, like firesorb, or microcapsules such as nanometer structure material (the encapsulation consists of polymeric compounds like Stoba which is diffused, in particular, only at elevated temperature out of the capsules and thus seals or isolates ionically the electrode).

Collector bands of copper and aluminum of 30 μm, respectively 20 μm are chosen in a further exemplary approach having the aim to produce a cell for a 10 C-charge and 20 C-discharge operation. These collector bands may simultaneously better cool the cell and the electrode material and are thus, respectively, able to improve current load capacity. Electrodes in the thickness range for the cathode of 55 to 125 μm and for the anode of 18 to 80 μm are produced by calandering on the collector binders. The above-mentioned electrodes in the higher range of the thickness as mentioned are used in “high energy”-cells and, respectively, the thin electrodes are used in “high power”-cells. The above-mentioned stabilizers and electrically conductive additives are injected according to procedure in an amount of maximum 3% each.

The anode used according to the present Examples is preferably a graphite system consisting of a “soft carbon” coated with a “hard carbon”, wherein “hard carbon” is only present in an amount of up to 15%.

The cathode is configured for large size cell packs which means, in particular, coated as or coated in a pattern form. The cells manufactured accordingly show a stable load capacity up to 10 C, are aging resistant and have superior cycle properties >5,000 complete cycles (80%) even in the “high energy”-embodiment. By means of inserting a copper fluff or a chip, the polymers injected are enclosed and thus prevented from building a partly “hot spot”. The “high-power”-embodiment is very cycle-stable and resilient above >20° C.

With respect to electrolytes it can be shown that it is sufficient to use simple mixtures like EC/EM 1:3 with an additive like VC or a “redox shuttle” (without further, partly polluting, questionable additives). The additive effect is provided based on the microinjection into the electrode. Thus, the electrolyte is environmentally friendly and cheaper. Also, a very good result may be achieved in the “cold cracking test”.

1-17. (canceled)

18. A cathodic electrode for an electrochemical cell, comprising:
at least one substrate, onto which at least one active material is applied or deposited, wherein the active material comprises a mixture of a lithium-nickel-manganese-cobalt composite oxide (NMC) which is not present in a spinel structure, and a lithium-manganese oxide (LMO) in a spinel structure.

19. The cathodic electrode according to claim 18, wherein the active material comprises at least 30 mole-% of lithium-nickel-manganese-cobalt composite oxide as well 10 mole-% lithium-manganese oxide, relative to the total amount of the active material in the cathodic electrode.

20. The cathodic electrode according to claim 18, wherein NMC and LMO together make up at least 60 mole-% of the active material relative to the total amount of active material in the cathodic electrode.

21. The cathodic electrode according to claim 18, wherein the active material consists essentially of NMC and LMO and thus contains no other active materials in an amount of more than 2 mole-%.

22. The cathodic electrode according to claim 18, wherein the material applied to the substrate comprises 80 to 90 weight-% of the active material relative to the total amount of the material as applied to the substrate.

23. The cathodic electrode according to claim 18, wherein the ratio of weight parts of NMC as active material to LMO as active material is 9 (NMC):1 (LMO) up to 3 (NMC):7 (LMO).

24. The cathodic electrode according to claim 18, wherein the lithium-nickel-manganese-cobalt composite oxide and the lithium-manganese oxide is present in particulate form.

25. The cathodic electrode according to claim 18, wherein the cathodic electrode comprises a stabilizer.

26. The cathodic electrode according to claim 25, wherein the stabilizer comprises at least one porous ceramic material comprised in a separator used in the respective electrochemical cell.

27. The cathodic electrode according to claim 18, wherein the lithium-nickel-manganese-cobalt composite oxide (NMC) has the following stoichiometry:
[Co_{1/3}Mn_{1/3}Ni_{1/3}]O₂, wherein the content of Li, Co, Mn, Ni, and O can vary about +/−5%.

28. The cathodic electrode according to claim 18, wherein the lithium-manganese oxide (LMO) comprises the following stoichiometry: Li₁₊ₓMn_{2-y}M_{y}O₄, wherein M is at least one metal and −0.5≦x≦0.5 as well as 0≦y≦0.5

29. An electrochemical cell comprising:
a cathodic electrode according to claim 18;
an anodic electrode; and
a separator, which is at least arranged partly between the cathodic electrode and the anodic electrode.

30. The electrochemical cell according to claim 29, wherein the separator comprises at least one porous ceramic material.

31. The electrochemical cell according to claim 29, wherein the separator is coated on one side, or on both sides, with a polyether imide.

32. The electrochemical cell according to claim 30, wherein the ceramic material is selected from the group consisting of oxides, phosphates, sulfates, titanates, silicates, aluminum silicates or borates of at least one metal ion.

33. The electrochemical cell according to claim 29, wherein the separator has a thickness of 2 to 50 μm.

34. A method, comprising:
Providing the cathodic electrode of claim 18 in a lithium-ion battery for an electronic tool, an electric vehicle, or in stationary battery applications.

35. The method of claim 34, wherein the cathodic electrode is provide in a completely or predominantly electrically operated vehicle or in a vehicles operated as a hybrid in which the electrode is provided together with a combustion engine or together with a fuel cell.
